(19) United States
(12) Patent Application Publication
(10) Pub. No.: US 2002/0104091 A1
(43) Pub. Date: Aug. 1, 2002

(54) Home audio video interoperability implementation for high definition passthrough, on-screen display, and copy protection

(76) Inventors: Amal Prabhu, Santa Clara, CA (US); Raymond Jensen, Sunnyvale, CA (US); David G. Gaxiola, San Jose, CA (US)

Correspondence Address: Tom Van Zandt, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/770,871

(22) Filed: Jan. 26, 2001

(51) Int. Cl. H04N 7/18

(52) U.S. Cl. 725/80; 725/78; 348/74

(57) ABSTRACT

A method for interfacing a digital set-top box with a digital television in accordance with Electronics Industries Association standard 775A. According to one embodiment, a multiple program transport stream is received and filtered. The filtering process produces a single program transport stream based on a program selected by a user. The single program transport stream is provided to the digital television over a 1394 bus in accordance with EIA standard 775A. The program association information associated with the single program transport stream is also provided to the digital television. In one embodiment, the invention contains a component performing on-screen display function for user interface information displayed on a DTV.

### FIELD OF THE INVENTION

The present invention relates generally to electronic networks and more specifically to methods and apparatuses for providing a home audio video interoperability (HAVi) implementation for high definition passthrough, on-screen display, and copy protection.

### INTRODUCTION AND BACKGROUND OF THE INVENTION

A typical home audiovisual equipment complement includes a number of components, e.g., a radio receiver, a CD player, speakers, a television, a VCR, etc. Components are often connected to each other, via sets of wires for example. The typical home audiovisual system contains a central component such as the radio receiver or tuner/decoder. New devices emerge and become popular, and are added, by consumers, to the audiovisual system. The new device is simply “plugged” into the system next to the existing devices. Typically this is accomplished by plugging the device into an open input on the back of the tuner, or some other device coupled to the tuner.

A number of problems are associated with this method of expanding the audiovisual system. Problems arise due to the incompatibility of the various consumer devices and the lack of functional support for differing devices within a system. Another problem is the number of controls needed for the new and differing devices within the system. Each new device coupled to the system may lead to another dedicated remote control for the user to keep track of and learn to operate.

To address these problems the home audio video interoperability (HAVi) standard has been developed. The HAVi standard provides a communication architecture in which consumer electronic (CE) devices can be integrated. This allows the CE devices to communicate with, and control, one another. The HAVi standard implements this integration using an IEEE 1394 (1394) serial communication bus. The 1394 local bus architecture creates a dynamic network within which a 1394 capable device can be inserted at any time and be ready for use.

The HAVi standard was designed to allow the networking of various consumer electronics devices, however, the devices that HAVi was designed to network do not include a digital television (DTV). There is no way in the HAVi specification to communicate with a DTV. DTVs are controlled by Electronics Industries Association standard 775A (EIA 775A). EIA 775A is a specification for sending video and user interface information to a DTV over a 1394 interface.

A DTV requires a set-top box (STB), or equivalent functionality, to translate incoming digital signals. Software is required to pass the high definition signal of the DTV to the to the STB.

### SUMMARY OF THE INVENTION

The present invention provides methods and apparatuses for passing secure standard or high definition video streams from a digital set-top box to a digital television in accordance EIA standards 775A and 799. A multiple program transport stream is received. The stream is then filtered to a single program transport stream based on a program selected by a user. The single program transport stream is provided to the digital television over a 1394 bus in accordance with EIA standards 775A and 799. In one embodiment, the invention contains a component performing on-screen display function for user interface information displayed on a DTV.

### BRIEF DESCRIPTION OF THE DRAWINGS

The objects, features, and advantages of the present invention will be apparent to one skilled in the art from the following detailed description in which:

FIG. 1 is a block diagram of the system in accordance with one embodiment of the present invention;

FIG. 2 is a block diagram of the high definition passthrough functionality of one embodiment of the present invention;

FIG. 3 is a process flow diagram of the high definition transmission in accordance with one embodiment of the present invention;

FIG. 4 represents a block diagram of the OSD functionality of one embodiment of the present invention;

FIG. 5 is a process flow diagram of the OSD functionality according to one embodiment of the present invention;

FIG. 6 represents a block diagram of the CP functionality of an embodiment of the present invention;

FIG. 7 is a process flow diagram of the CP functionality according to one embodiment of the present invention.

### DETAILED DESCRIPTION

The present invention includes software that integrates communication functionality to communicate using IEEE 1394, EIA 775A, and HAVi specifications.

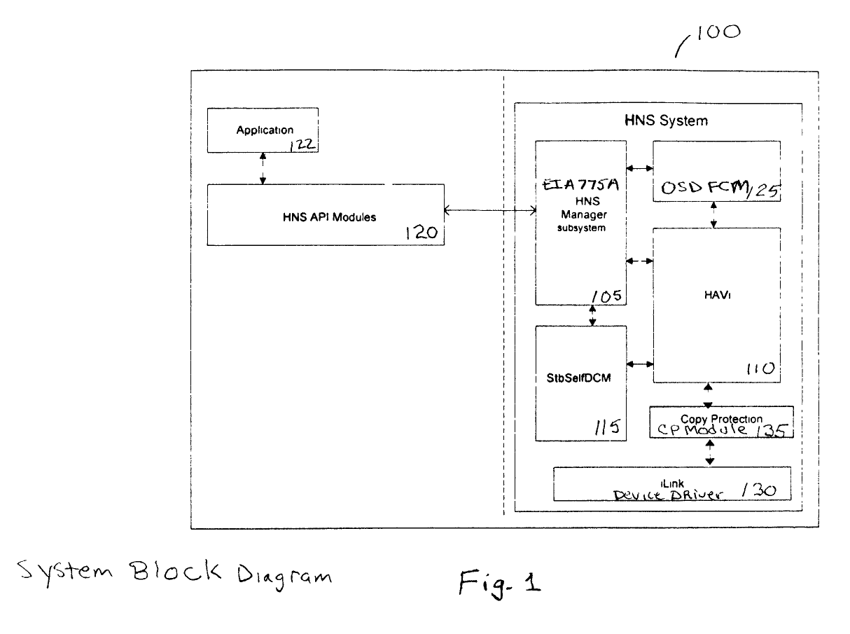

FIG. 1 is a block diagram of a home network software (HNS) system in accordance with the present invention. The HNS system 100 shown in FIG. 1 includes HNS manger subsystem 105 coupled to the HNS application program interface (API) modules 120. In one embodiment, the HNS API modules 120 are two libraries that provide an interface between the system functionality and external HAVi APIs. Thus, HAVi APIs may be abstracted from the external applications (e.g., application 122). In one embodiment the HNS API modules may be HAVi software elements. The EIA 775A HNS manager subsystem manages the high definition passthrough (HDP), on-screen display (OSD), and copy protection (CP) functionality and provides the interface between the HNS API modules and the system functionality (i.e., the HDP, OSD, and CP services). This allows an application from another process space to interact with the EIA 775A HNS manager subsystem 105.

The HAVi stack 110 shown in FIG. 1 is a software system to provide support for communication electronic devices. The HAVi stack contains a communication media manager for 1394, a message system, a registry, an event manager, a device control module manager, a stream manger, and a resource manager. All of the components are implemented as per HAVi specification.

The digital television device control module, OSD FCM 125 shown in FIG. 1 is a functional control module for the on-screen display functionality. The OSD FCM 125 assists in interaction with the DTV device. The OSD FCM 125 discovers the DTV in accordance with the context of the EIA standard 775A for OSD and provides interface to the HAVi software elements for getting the OSD-related information about the DTV and for writing OSD data into the segment register of the DTV.

In one embodiment, a STB is controlled by the set-top box self device control module (StbSelfDCM) 115 shown in FIG. 1. The StbSelfDCM 115 is a HAVi DCM, it is meant to control the STB using the HAVi APIs. Alternatively, a device with equivalent functionality is used in place of the STB (i.e., a device having the ability to filter the incoming program transport stream and send the user-selected portion of the stream to the DTV).

The StbSelfDCM also incorporates within itself an audiovisual communications (AVC) command processor that allows the incoming AVC commands to be converted to HAVi events and HAVi API messages. Because AVC defines asynchronous connections that are used by the EIA standard 775A specification to implement OSD, the StbSelfDCM 115 also handles the asynchronous connections. This helps in coupling AVC with HAVi.

The iLink device driver 130 shown in FIG. 1 provides the interface to the 1394 bus. It allows the HNS application software to send and receive 1394 asynchronous data. It also provides the interface to isochronous bus management and streaming high definition video over the 1394 bus.

In one embodiment, the copy protection 135 shown in FIG. 1 incorporates a 5C authentication protocol that allows the set-top box to selectively stream out the video content on the 1394 bus. The video content is sent only to authenticated devices on the 1394 bus.

High Definition Passthrough (HDP):

The HDP functionality allows a digital STB to receive a full program transport stream, consisting of, for example, 66 packets, and filter it to a single program transport stream based upon user selection. The single program transport stream is sent over a 1394 bus to the DTV in accordance with EIA775A specification. In one embodiment, the iLink driver 130 provides an interface to insert or halt the insertion of the program association information (PAI) into the stream that allows the DTV to play the video stream.

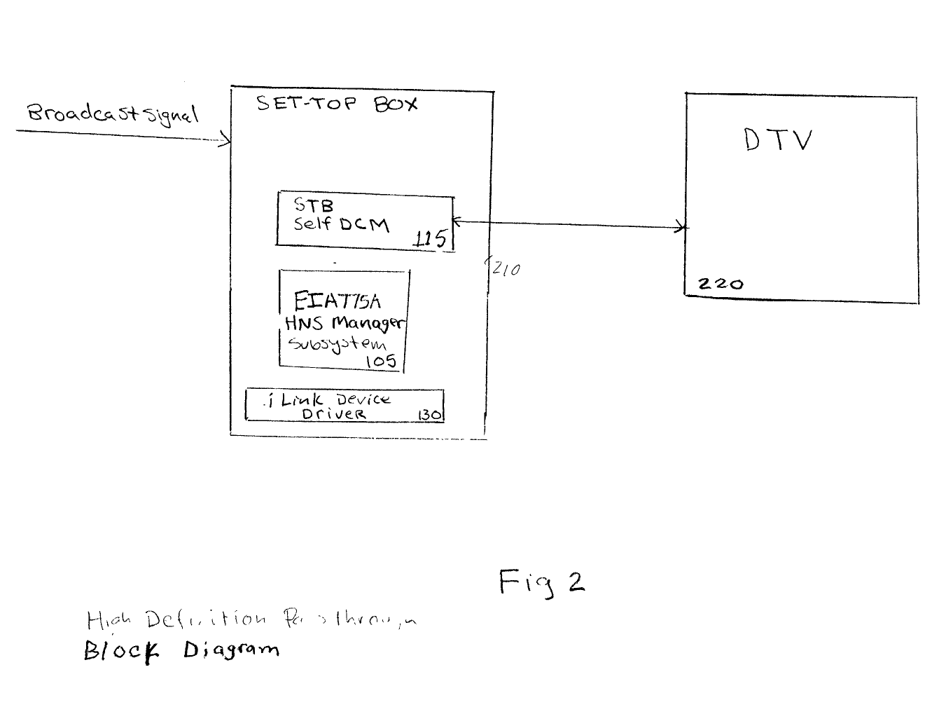

FIG. 2 represents a block diagram of the HDP functionality of an embodiment of the present invention. When the STB 210 shown in FIG. 2 is connected to the DTV 220, the DTV 220 detects the STB 210 and is provided with information regarding the STB by the StbSelf DCM 115. The DTV 220 establishes an isochronous connection with the STB 210. This connection is detected by EIA 775A HNS manager subsystem 105, which manages the connection. The STB 210 receives the broadcast signal and the EIA 775A HNS manager subsystem 105 tailors the program association and management tables to identify the selected MPEG II stream which represents the program the user wants displayed on the DTV. The information corresponding to the selected stream is then passed along with the stream to the DTV. Once the system is aware of the channel the user has selected, the software ensures that only that channel is passed. The EIA 775A HNS manager subsystem then starts the high definition (HD) transmission.

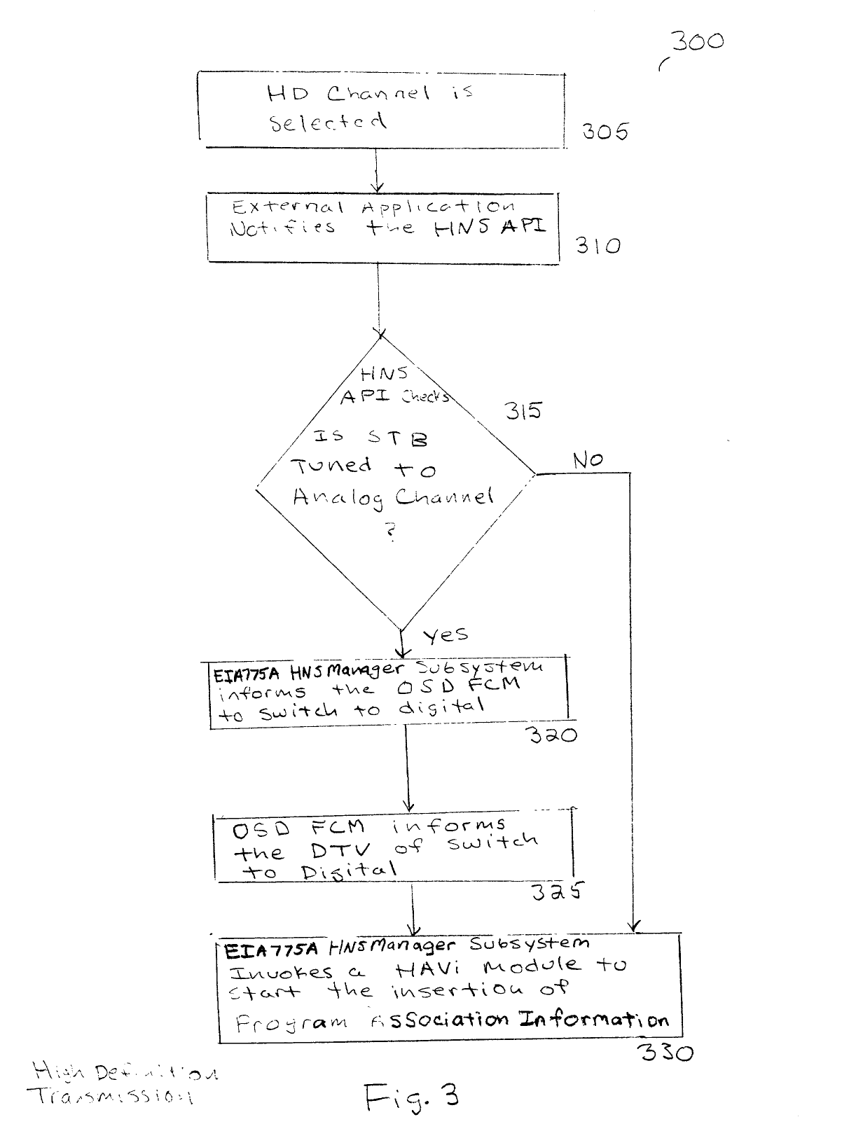

FIG. 3 is a process flow diagram of the HD transmission according to one embodiment of the present invention. The process 300 shown in FIG. 3 begins at operation 305 in which a high definition channel is selected. In operation 310 an external application (e.g., 122) calls the HNS API module 120 to indicate that a HD channel has been selected. In operation 315 the HNS API module 120 checks to see if the STB 210 is tuned to an analog channel. In one embodiment, HNS API module 120 notifies the HNS system 100 of the result of this check.

If the STB 210 is tuned to an analog channel, then the EIA 775A HNS manager subsystem 105 informs the OSD FCM 125 to switch to digital in operation 320. The OSD FCM125 informs the DTV of the switch to digital in operation 325. In operation 330 the EIA 775A HNS manager subsystem invokes a module of the Havi stack 110 to start the insertion of the program association information. The program association information could be, for example a program association table defined by Motion Picture Expert Group II (MPEG II). If, in operation 315, the STB 210 was not tuned to an analog channel, the process continues from that point with operation 330 as described above.

The EIA 775A HNS manager subsystem 105 is aware of the channel currently being played. If the STB switches from HD, the EIA 775A HNS manager subsystem 105 notifies the HNS system 100. The OSD FCM 125 sends a command notifying the DTV of the channel switch and the EIA 775A HNS manager subsystem 105 notifies the HAVi module to stop insertion of the program association information.

On-Screen Display (OSD):

The OSD functionality provides the capability for a STB to display user interface information on a DTV when it is switched to a high definition channel. As per EIA standard 775A specification, the user interface information is sent using asynchronous transactions over a 1394 bus. EIA 775A uses audiovisual connection (AVC) specified asynchronous connections for the protocol to send large asynchronous data from a STB to a DTV. The DTV acts as a controller and a consumer while the HNS system 100 software is the producer.

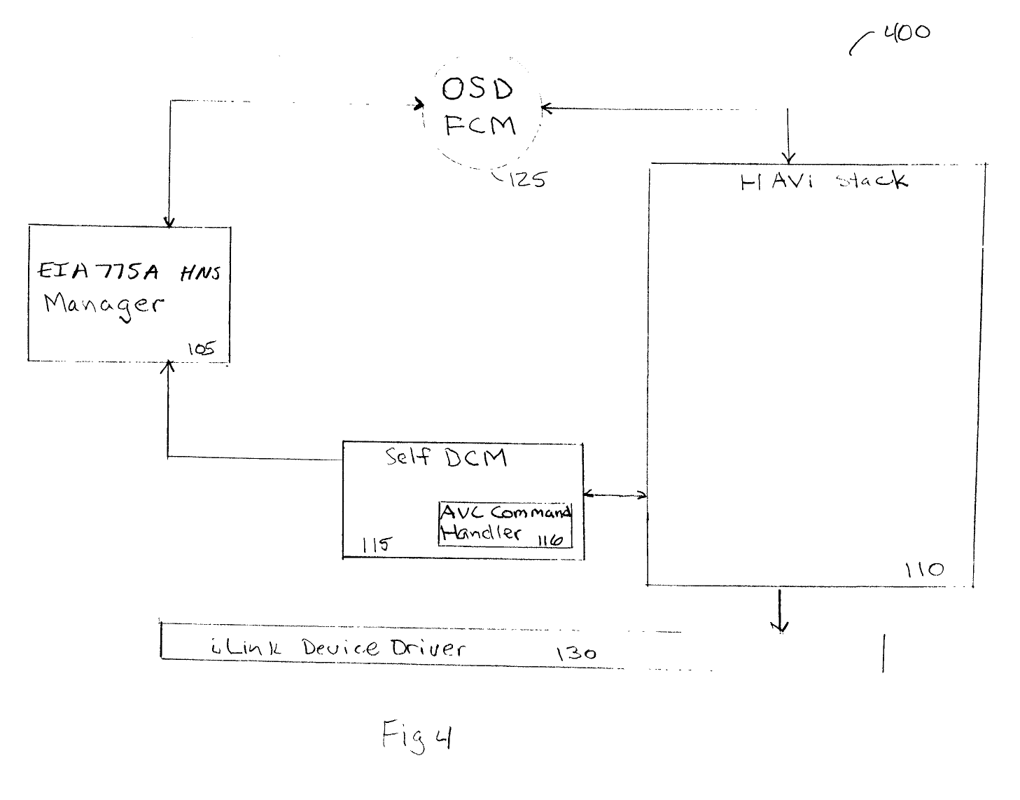

FIG. 4 represents a block diagram of the OSD functionality of an embodiment of the present invention. The system 400 shown in FIG. 4 includes components of system 100 of FIG. 1. When a DTV is connected to a STB the HAVi stack 110 directs the software to create an OSD FCM 125. The OSD FCM 125 is a HAVi software entity that understands the protocols for a DTV and can, therefore, communicate with the DTV. The asynchronous connections required by EIA standard 775A are implemented through interaction between the OSD FCM 125, the StbSelf DCM 115, and the EIA775A HNS manger 105. The StbSelfDCM 115 contains an AVC command processor 116 that converts changes to the output asynchronous plug register from the DTV into HAVi notifications.

The AVC command processor handles the incoming AVC commands. The AVC commands are used by the DTV to discover a potential OSD device and setup the asynchronous connection with such a device. In one embodiment the set-top box is an OSD producer device. The EIA775A HNS manger 105 manages what needs to be done in order to determine that the DTV is trying to establish a connection. The EIA775A HNS manger 105 integrates the functionality of the 1394 standard, the EIA 775A standard, and the HAVi specification so that all three communicate correctly for HDTV. The present invention is not limited to HAVi, but can be implemented in a non-HAVi setting. In a non-HAVi approach the DTV sets up the connection and communicates to the iLink device driver 130 that the connection has been set up.

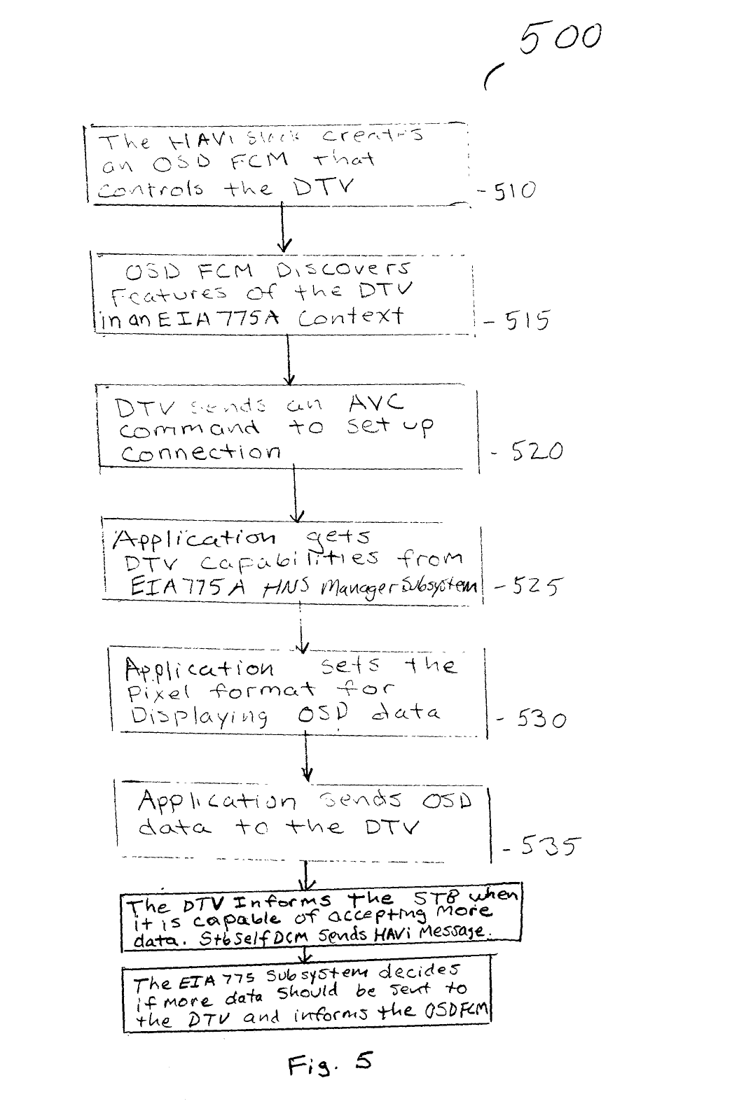

In order to control the on-screen display of a DTV, the system communicates with the DCM of the DTV. FIG. 5 is a process flow diagram of the OSD functionality according to one embodiment of the present invention. The process 500 shown in FIG. 5 begins at operation 505 in which the HAVi stack 110 creates an OSD FCM 125 that controls the DTV. In operation 510 the OSD FCM 125 discovers features of the DTV in an EIA standard 775A context. The DTV sends an AVC command to set up a connection, operation 515. An external application, for example 122, receives the DTV capabilities from the EIA775A HNS manger 105 in operation 520.

One of the capabilities the external application receives is the capability of detecting the asynchronous connection and disconnection. When the DTV discovers that the STB is an EIA775A producer device, the DTV sets up the connection by sending an AVC asynchronous connection command. This command is processed inside the StbSelfDCM 115 that sets up the output asynchronous plug register. The connection is set after the DTV writes the output plug register with its segment buffer capacity. The StbSelfDCM 115 uses HAVi events to notify users of this connection. The EIA775A HNS manger 105 monitors the HAVi events and notification is passed to the HNS API module 120 and finally to external application 122.

External application 122 is typically interested in knowing the capabilities of the DTV. As discussed above, this information is maintained in OSD FCM 125. When the application 122 queries for this information the EIA775A HNS manger 105 provides this information by accessing the OSD FCM 125.

In operation 525 the application sets the pixel format for displaying OSD data. The HNS API modules 120 transfer the display format data to the OSD FCM 125. In one embodiment, the display format data is transferred via a region of shared memory. The OSD FCM 125 notifies the DTV about this information. The OSD FCM 125 maintains the information about the asynchronous segment buffer. For flow control purposes, the OSD FCM 125 also provides an interface to update the input asynchronous plug register of the DTV.

In operation 530 the OSD data is sent to the DTV by the application. The OSD data is formatted as per EIA standard 775A by the application and then given to the HNS API module 120. The OSD data is passed on to the OSD FCM 125. In one embodiment the OSD data is copied into a region of shared memory and the OSD FCM 125 is notified of its presence. The OSD FCM 125 contains the software to write the OSD data into the segment buffer and update the input asynchronous plug register of the DTV. If the OSD data is greater than the size of the segment buffer, the OSD FCM 125 indicates to the DTV that there is more data. In one embodiment, the DTV updates the output asynchronous plug register value and the OSD FCM 125 resumes OSD data transfer. In an alternate embodiment, the OSD data is not transferred by way of shared memory, but through direct API invocation or some other form of messaging.

In operation 535 the DTV informs the STB when it is capable of receiving more data. The DTV does this by updating the output plug status. The STBSelfDCM translates the information (i.e., that the DTV is capable of receiving more data) to a HAVi message and passes the message to the EIA 775A Subsystem in operation 540. In operation545 the EIA 775A Subsystem then decides if more data should be sent to the DTV. If there is a need to send more data from the STB to the DTV, the EIA 775A Subsystem informs the OSD FCM.

Copy Protection (CP):

For one embodiment, video authenticators are loaded into the STB at the time of manufacture. The authenticators may also be loaded at user installation, or at a later time. Copy protection (CP) involves communicating with the STB and determining if encryption keys are required. An embodiment of the present invention communicates with the STB, obtains the encryption keys, if required, and passes them to the driver of the CP software.

For one embodiment, the video stream has an embedded piece of information in the MPEGII non-video component of the stream. This information is the encryption management identifier (EMI). The EMI is evaluated by the HNS API module 120. If the video stream currently being played needs to be encrypted then the CP function is initiated, and the video stream is encrypted from the STB to the DTV.

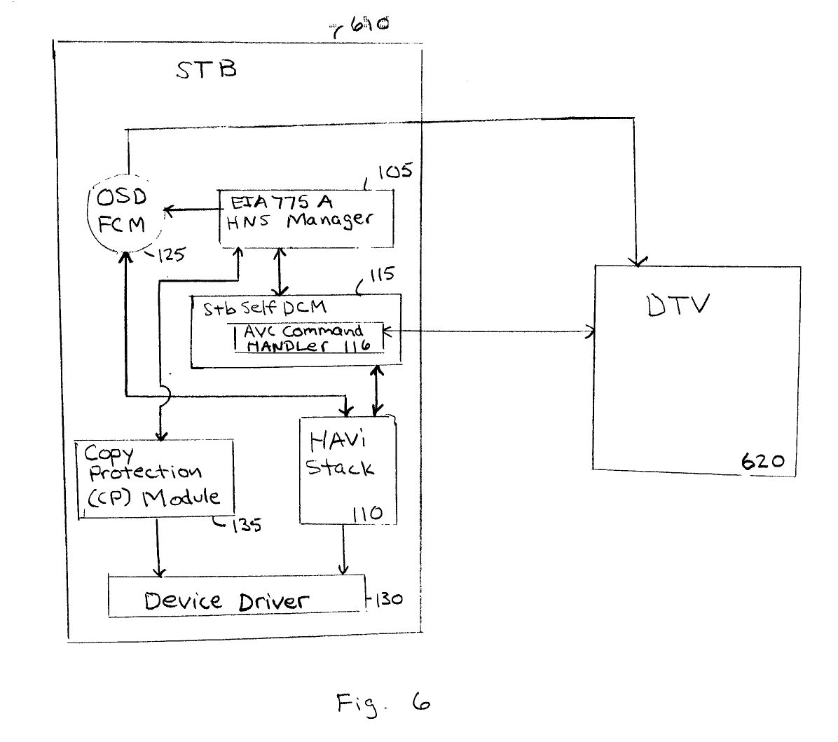

FIG. 6 represents a block diagram of the CP functionality of an embodiment of the present invention. The system 600 shown in FIG. 6 includes the CP module 135 that communicates with the device driver 130 and directs the driver to encrypt, if necessary, based on the EMI information. After encryption the DTV 620 sends an AVC command to the AVC command handler 116. The AVC command contains certain key information. The StbSelfDCM 115 that contains the AVC command handler 116 is implemented as a HAVi module. The AVC command is therefore converted to a HAVi message. The HAVi message is transmitted from the AVC command handler to the EIA775A HNS manger 105. The EIA775A HNS manger 105 determines that these messages are related to copy protection and registers CP module 135 and therefore sends the HAVi messages to CP module 135.

The CP module sends a response back to the EIA775A HNS manger 105 that is forwarded to the StbSelfDCM 115. The CP module 115 authenticates the status of the DTV 620 and sends the required copy protection commands using the services of the OSD FCM.

In order to communicate with the DTV 620, the EIA775A HNS manger 105 communicates with the OSD FCM 125 which is the device driver for the DTV. The OSD FCM 125 uses AV/C to transmit the copy protection commands to the DTV. This allows the CP module 135, with all of its copy protection algorithms and controlling software, to communicate with the actual device it is targeting.

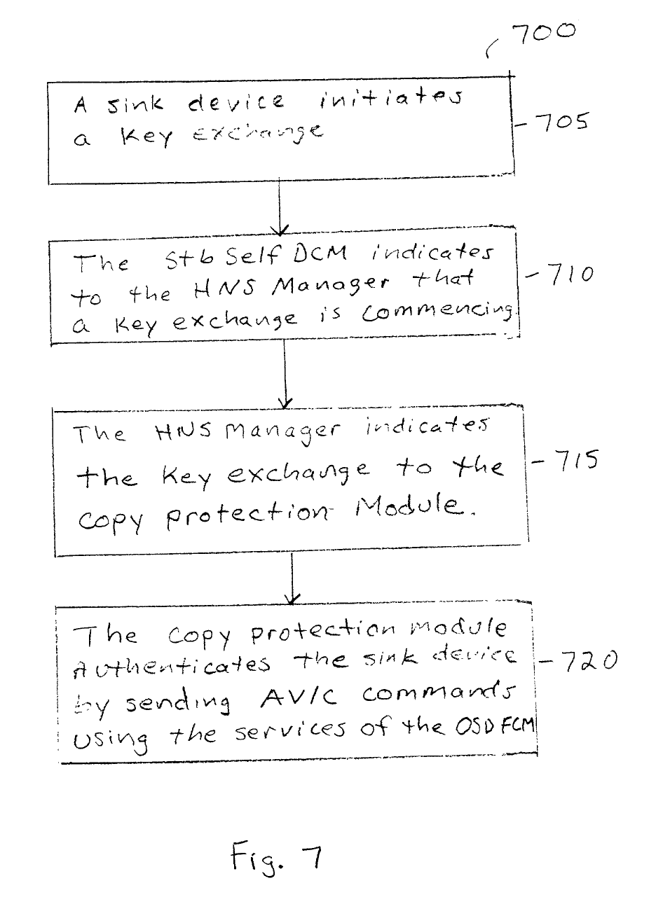

FIG. 7 is a process flow diagram of the CP functionality according to one embodiment of the present invention. The process 700 shown in FIG. 7 begins at operation 705 in which a sink device (e.g., DTV) initiates a key exchange. This happens through the transmission of an AVC command by the sink device to a source device (e.g., STB). This AVC command for key exchange is received by the AVC command handler 116 of the source device.

In operation 710 the StbSelfDCM 115 indicates to the HNS manager 105 that a key exchange is commencing. In operation 715 the HNS manager 105 indicates the key exchange to the copy protection module. In order to authenticate the sink device, the copy protection module sends AV/C commands using the services of the OSD FCM in operation 720.

The process of the present invention may be implemented through use of a machine-readable medium which includes any mechanism that provides (i.e. stores and/or transmits information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

In the foregoing detailed description, the methods and apparatuses of the present invention have been described with reference to specific exemplary embodiments. It should be understood that the methods and apparatuses of the invention can be practiced with modification and alteration within the spirit and scope of the appended claims. The description is thus to be regarded as illustrative instead of limiting on the invention.

### APPENDIX A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39,637; Donna Jo Coningsby, Reg. No. 41,684; Florin Corie, Reg. No. 46,244; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Sanjeet Dutta, Reg. No. 46,145; Matthew C. Fagan, Reg. No. 37,542; Tarek N. Fahmi, Reg. No. 41,402; George Fountain, Reg. No. 37,374; James Y. Go, Reg. No. 40,621; James A. Henry, Reg. No. 41,064; Libby N. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George Brian Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Joseph Lutz, Reg. No. 43,765; Michael J. Mallie, Reg. No. 36,591; Andre L. Marais, under 37 C.F.R. § 10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Robert B. O'Rourke, Reg. No. 46,972; Daniel E. Ovanezian, Reg. No. 41,236; Kenneth B. Paley, Reg. No. 38,989; Gregg A. Peacock, Reg. No. 45,001; Marina Portnova, Reg. No. 45,750; William F. Ryann, Reg. 44,313; James H. Salter, Reg. No. 35,668; William W. Schaal, Reg. No. 39,018; James C. Scheller, Reg. No. 31,195; Jeffrey Sam Smith, Reg. No. 39,377; Maria McCormack Sobrino, Reg. No. 31,639; Stanley W. Sokoloff, Reg. No. 25,128; Judith A. Szepesi, Reg. No. 39,393; Vincent P. Tassinari, Reg. No. 42,179; Edwin H. Taylor, Reg. No. 25,129; John F. Travis, Reg. No. 43,203; Joseph A. Twarowski, Reg. No. 42,191; Tom Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Firasat Ali, Reg. No. 45,715; Justin M. Dillon, Reg. No. 42,486; Thomas S. Ferrill, Reg. No. 42,532; and Raul Martinez, Reg. No. 46,904, my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James R. Thein, Reg. No. 31,710, my patent attorney with full power of substitution and revocation, to prosecute this application and to transact all business in the Patent and Trademark Office connected herewith.

### APPENDIX B

### Title 37, Code of Federal Regulations, Section 1.56 Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclosure information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclosure all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made or record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

What is claimed is:

1. A method comprising:
receiving a multiple program transport stream;
filtering the multiple program transport steam to a single program transport stream based on a program selected by a user; and
providing the single program transport stream to a remote device over an Institute of Electrical and Electronics Engineers 1394 serial communication bus in accordance with Electronics Industries Associations standards 775A and 799.

2. The method of claim 1, further comprising:
determining the network topology of consumer electronic devices such that the program transport stream is directed to one or more specified consumer electronic devices.

3. The method of claim 1, further comprising:
directing a module that is not IEEE standard 775A compliant to access an application program interface such that the module transmits bitmap information to an IEEE standard 775A compliant remote device for display.

4. The method of claim 3, wherein the module is a Home Audio-Visual interoperability module that may exist locally or remotely.

5. The method of claim 1, further comprising:
tailoring program association information in accordance with Electronics Industries Association standard 775A; and
providing the tailored program association information to the remote device.

6. The method of claim 3, wherein the remote device is a digital television.

7. The method of claim 6, wherein the single program transport stream is a high definition video stream.

8. The method of claim 7, wherein the single program transport stream is provided to the remote device as an isochronous stream.

9. The method of claim 8, wherein the isochronous stream is copy-protected.

10. The method of claim 5, wherein the single program transport stream is provided only to authenticated remote devices on the Institute of Electrical and Electronics Engineers 1394 serial communication bus.

11. The method of claim 10, wherein authentication is implemented using an authentication protocol.

12. A method comprising:
receiving user interface information related to a remote device; and
formatting the information for transmission over an Institute of Electrical and Electronics Engineers 1394 serial communication bus in accordance with Electronics Industries Associations standard 775A and 799.

13. A device comprising:
means for receiving a multiple program transport stream;
means for filtering the multiple program transport steam to a single program
transport stream based on a program selected by a user; and
means for providing the single program transport stream to a remote device over an Institute of Electrical and Electronics Engineers 1394 serial communication bus in accordance with Electronics Industries Associations standards 775A and 799.

14. The device of claim 13, further comprising:
means for determining the network topology of consumer electronic devices such that the program transport stream is directed to one or more specified consumer electronic devices.

15. The device of claim 13, further comprising:
means for directing a module that is not IEEE standard 775A compliant to access an application program interface such that the module transmits bitmap information to an IEEE standard 775A compliant remote device for display.

16. The device of claim 15, wherein the module is a Home Audio-Visual interoperability module that may exist locally or remotely.

17. The device of claim 13, further comprising:
means for tailoring program association information in accordance with Electronics Industries Association standard 775A; and
means for providing the tailored program association information to the remote device.

18. The device of claim 15, wherein the remote device is a digital television.

19. The device of claim 18, wherein the single program transport stream is a high definition video stream.

20. The device of claim 19, wherein the single program transport stream is provided to the remote device as an isochronous stream.

21. The device of claim 20, wherein the isochronous stream is copy-protected.

22. The device of claim 21, wherein the single program transport stream is provided only to authenticated remote devices on the Institute of Electrical and Electronics Engineers 1394 serial communication bus.

23. The device of claim 22, wherein authentication is implemented using an authentication protocol.

24. A machine-readable medium that provides executable instructions, which when executed by a processor, cause said processor to perform a method comprising:
receiving a multiple program transport stream;
filtering the multiple program transport steam to a single program transport stream based on a program selected by a user; and
providing the single program transport stream to a remote device over an Institute of Electrical and Electronics Engineers 1394 serial communication bus in accordance with Electronics Industries Associations standards 775A and 799.

25. The machine-readable medium of claim 24, wherein the method further comprises:
determining the network topology of consumer electronic devices such that the program transport stream is directed to one or more specified consumer electronic devices.

26. The machine-readable medium of claim 24, wherein the method further comprises:
directing a module that is not IEEE standard 775A compliant to access an application program interface such that the module transmits bitmap information to an IEEE standard 775A compliant remote device for display.

27. The machine-readable medium of claim 26, wherein the module is a Home Audio-Visual interoperability module that may exist locally or remotely.

28. The machine-readable medium of claim 24, wherein the method further comprises:
tailoring program association information in accordance with Electronics Industries Association standard 775A; and
providing the tailored program association information to the remote device.

29. The machine-readable medium of claim 26, wherein the remote device is a digital television.

30. The machine-readable medium of claim 29, wherein the single program transport stream is a high definition video stream.

31. The machine-readable medium of claim 30, wherein the single program transport stream is provided to the remote device as an isochronous stream.

32. The machine-readable medium of claim 31, wherein the isochronous stream is copy-protected.

33. The machine-readable medium of claim 28, wherein the single program transport stream is provided only to authenticated remote devices on the Institute of Electrical and Electronics Engineers 1394 serial communication bus.

34. The machine-readable medium of claim 33, wherein authentication is implemented using an authentication protocol.

35. A machine-readable medium that provides executable instructions, which when executed by a processor, cause said processor to perform a method comprising:
receiving user interface information related to a remote device; and
formatting the information for transmission over an Institute of Electrical and Electronics Engineers 1394 serial communication bus in accordance with Electronics Industries Associations standard 775A and Electronics Industries Association standard 779.
